(19) United States
(12) Patent Application Publication
(10) Pub. No.: US 2008/0021743 A1
(43) Pub. Date: Jan. 24, 2008

(54) Homeowners Housing Price Protection Program Against Selling Losses

(76) Inventor: Adam Milton Sciacca, Amelia Island, FL (US)

Correspondence Address: Adam M. Sciacca, 1786 Hammock Court, Amelia Island, FL, 32034, US

(21) Appl. No.: 11/278,938

(22) Filed: Jul. 24, 2006

(51) Int. Cl. G06Q 40/00

(52) U.S. Cl. 705/4; 705/35

(57) ABSTRACT

The product protects the value of a “for sale” home against a falling real estate market. A hedge against fluctuating home prices is created by purchasing a hedge insurance “Policy.” The home is appraised, by a certified appraiser, when the “Policy” is issued. The “Policy” guarantees, that the appraised value of the home will be paid, under certain conditions, if the home sells while the policy is in effect. The home is reappraised at the time of the sale to establish a fair value, and if the homeowner. received less than original appraisal, the “Policy” pays the difference of the reappraised value or the sales price, whichever was greater.

My invention is a separate and unique type of insurance (“Policy”) for homeowners, who are trying to sell their homes and want to protect (hedge) themselves against declining housing prices.

The home will be appraised, by a certified appraiser, when the “Policy” is issued. The “Policy” would guarantee, that the appraised value of the home would be paid, under certain conditions, if the home was sold while the policy was in effect. For example, if a home was appraised at a value of $90,000.00, when the “Policy” was issued, the “Policy” would guarantee the owner of the home $90,000 at resale under certain conditions and as long as the policy was in effect. The home would be reappraised at the time of the sale to establish a fair value, and if the homeowner received less than $90,000, the “policy” would pay the difference of the reappraised value or the sales price, whichever was greater.

In the above example, if the home sold for $80,000 and it was reappraised for $90,000 at the time of the sale, the homeowner would not be reimbursed because the home was sold for a lower price than the appraised value and the appraised value was equal to the “Policy” appraised value. However, if the home was sold for $85,000 and was appraised at $75,000, the “Policy” owner would get $5,000, the difference between the original $90,000 appraisal and the selling price of $85,000.

The “Policy” would be issued for a period of six months/one year. The insurer (“Policy” issuer) would have the right to select any qualified and certified appraiser of their choice.

The price of the “Policy” would be determined by several factors including the appraised value of the property, geographic area, and price volatility of the geographic area. Disclaimers would be included for situations such as, no payout if the home was completely destroyed (Hurricane, Fire, Terrorism, Earthquake, etc.).

I claim the invention entitled HOMEOWNERS HOUSING PRICE PROTECTION PROGRAM AGAINST SELLING LOSSES as described in the separate specification sheet attached herewith is unique and distinct for the following reason:

1. There are currently no insurance or price hedging policies available or marketed to protect home sellers against falling home values.
